(19) United States
(12) Patent Application Publication
(10) Pub. No.: US 2023/0032552 A1
(43) Pub. Date: Feb. 2, 2023

(54) COPING WORK DISPLAY METHOD, RECORDING MEDIUM, AND ROBOT SYSTEM

(71) Applicant: SEIKO EPSON CORPORATION, Tokyo (JP)

(72) Inventor: Takayuki MAEDA, SHIOJIRI-SHI (JP)

(21) Appl. No.: 17/874,322

(22) Filed: Jul. 27, 2022

(30) Foreign Application Priority Data
Jul. 29, 2021 (JP) 2021-124153

(51) Int. Cl. B25J 9/16; B25J 13/08

(52) U.S. Cl. CPC B25J 9/1674; B25J 9/161; B25J 9/163; B25J 13/085

(57) ABSTRACT

A coping work display method according to an aspect of the present disclosure is a coping work display method for displaying coping work executed when an abnormality occurs in a robot, the coping work display method including a first step of detecting the abnormality that occurs in the robot, a second step of acquiring, from a storing section storing abnormality information indicating the abnormality that occurs in the robot and a plurality of kinds of coping work information indicating coping work for eliminating the abnormality of the robot related to the abnormality information, the plurality of kinds of coping work information related to the abnormality detected in the first step, and a third step of displaying the plurality of kinds of coping work information acquired in the second step.

The present application is based on, and claims priority from JP Application Serial Number 2021-124153, filed Jul. 29, 2021, the disclosure of which is hereby incorporated by reference herein in its entirety.

### BACKGROUND

### 1. Technical Field

The present disclosure relates to a coping work display method, a recording medium, and a robot system.

### 2. Related Art

In recent years, in a factory, automation of work manually performed in the past has been accelerated by various robots and robot peripheral equipment because of a steep rise in personal expenses and a labor shortage. For example, in a robot system described in JP-A-09-076182 (Patent Literature 1), when an abnormality occurs in the robot system, a part where the abnormality occurs and a procedure for eliminating the abnormality are displayed. Consequently, an operator can eliminate the abnormality while viewing displayed information.

However, in the related art, since only the information concerning the part where the abnormality occurs is displayed, even if a new abnormality is likely to occur in relation to the part where the abnormality occurs, the operator cannot grasp that the new abnormality is likely to occur.

### SUMMARY

A coping work display method according to an aspect of the present disclosure is a coping work display method for displaying coping work executed when an abnormality occurs in a robot, the coping work display method including: a first step of detecting the abnormality that occurs in the robot; a second step of acquiring, from a storing section storing abnormality information indicating the abnormality that occurs in the robot and a plurality of kinds of coping work information indicating coping work for eliminating the abnormality of the robot related to the abnormality information, the plurality of kinds of coping work information related to the abnormality detected in the first step; and a third step of displaying the plurality of kinds of coping work information acquired in the second step.

A non-transitory recording medium recording a coping work display program according to an aspect of the present disclosure is a non-transitory recording medium recording a coping work display program for displaying coping work executed when an abnormality occurs in a robot, the non-transitory recording medium recording a coping work display program for executing: a first step of detecting the abnormality that occurs in the robot; a second step of acquiring, from a storing section storing abnormality information indicating the abnormality that occurs in the robot and a plurality of kinds of coping work information indicating coping work for eliminating the abnormality of the robot related to the abnormality information, the plurality of kinds of coping work information related to the abnormality detected in the first step; and a third step of displaying the plurality of kinds of coping work information acquired in the second step.

A robot system according to an aspect of the present disclosure includes: a detecting section configured to detect an abnormality that occurs in a robot; a storing section storing abnormality information indicating the abnormality that occurs in the robot and a plurality of kinds of coping work information indicating coping work for eliminating the abnormality of the robot related to the abnormality information; an acquiring section configured to acquire, based on a detection result of the detecting section, the plurality of kinds of coping work information related to the detected abnormality from the storing section; and a display section configured to display the plurality of kinds of coping work information acquired by the acquiring section.

### BRIEF DESCRIPTION OF THE DRAWINGS

FIG. 1 is a diagram showing an overall configuration of a robot system according to an embodiment of the present disclosure.

FIG. 2 is a block diagram of the robot system shown in FIG. 1.

FIG. 3 is a diagram showing an example of a screen displayed on a display section included in the robot system shown in FIG. 1.

FIG. 4 is a diagram showing an example of a screen displayed on the display section included in the robot system shown in FIG. 1.

FIG. 5 is a diagram showing an example of a screen displayed on the display section included in the robot system shown in FIG. 1.

FIG. 6 is a diagram showing an example of a screen displayed on the display section included in the robot system shown in FIG. 1.

FIG. 7 is a diagram showing an example of a screen displayed on the display section included in the robot system shown in FIG. 1.

FIG. 8 is a diagram showing an example of a screen displayed on the display section included in the robot system shown in FIG. 1.

FIG. 9 is a table showing an example of data stored in a storing section included in the robot system shown in FIG. 1.

FIG. 10 is a table showing an example of data stored in the storing section included in the robot system shown in FIG. 1.

FIG. 11 is a table showing an example of data stored in the storing section included in the robot system shown in FIG. 1.

FIG. 12 is a table showing an example of data input to the storing section included in the robot system shown in FIG. 1.

FIG. 13 is a flowchart for explaining an example of a coping work display method according to the present disclosure.

### DESCRIPTION OF EXEMPLARY EMBODIMENTS

### First Embodiment

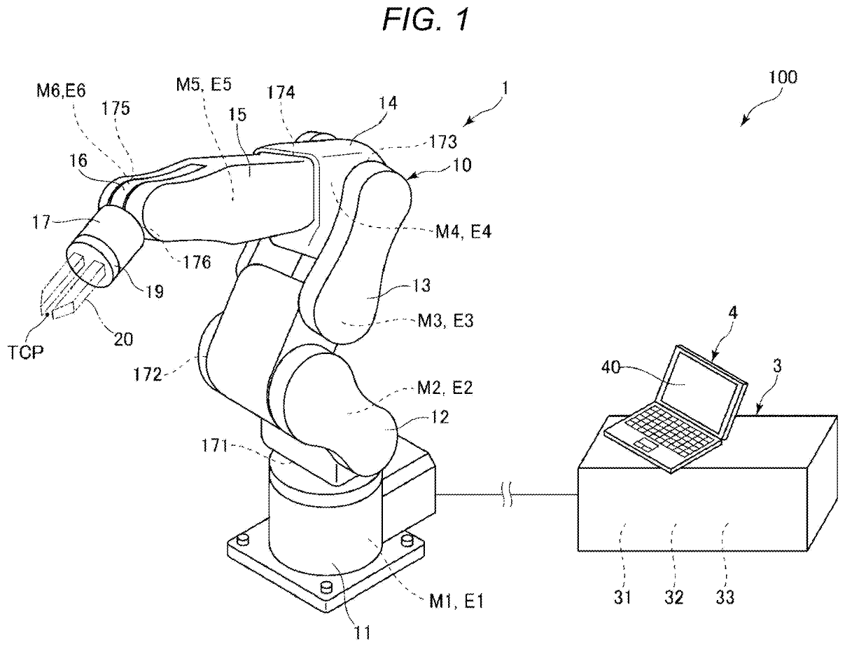

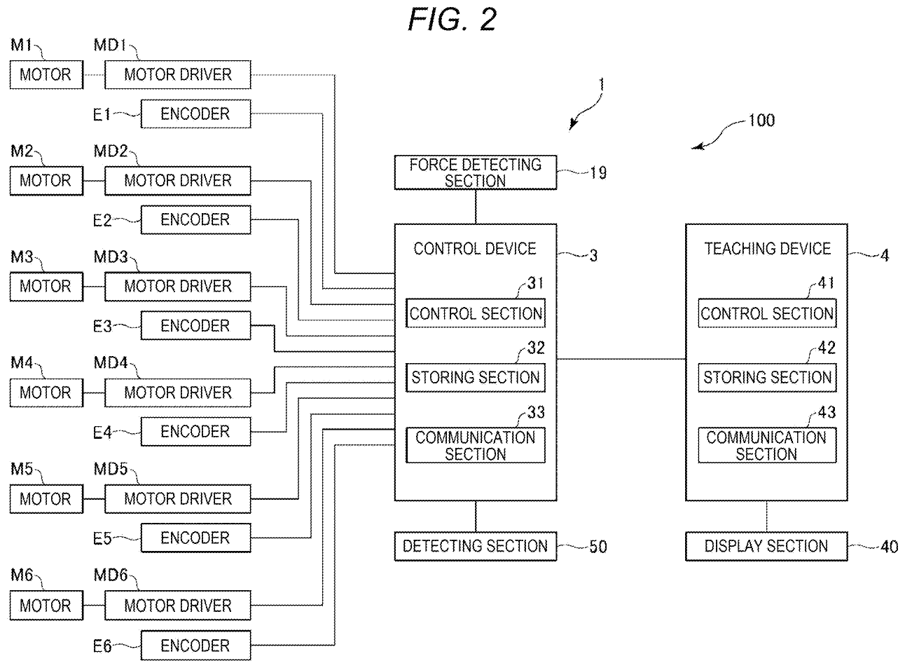

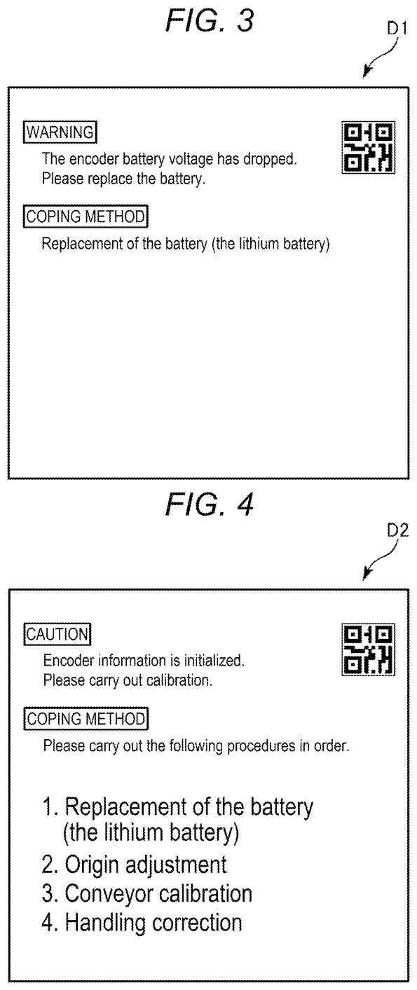

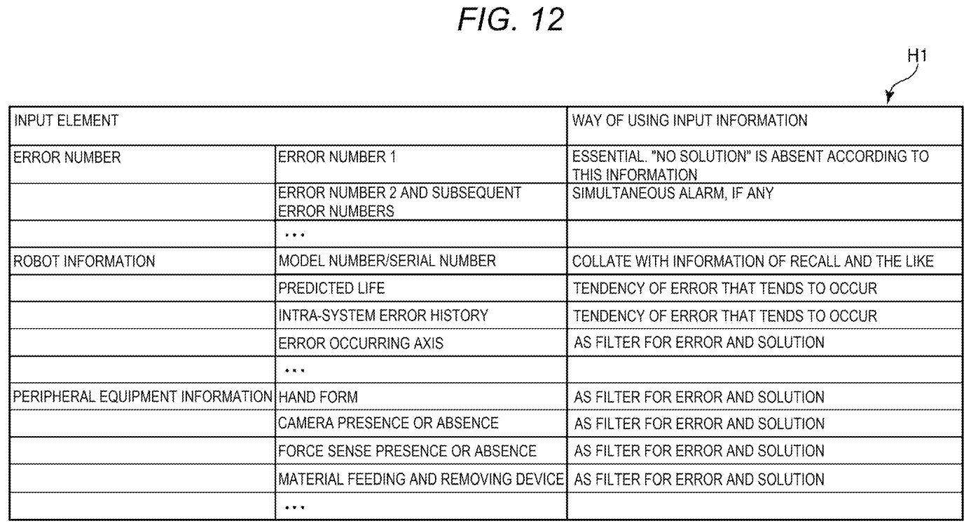

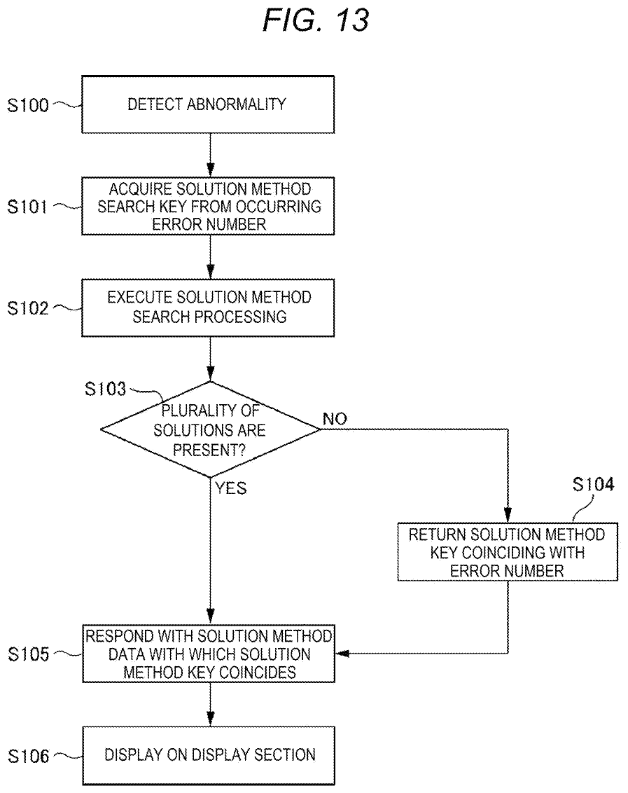

FIG. 1 is a diagram showing an overall configuration of a robot system according to an embodiment of the present disclosure. FIG. 2 is a block diagram of the robot system shown in FIG. 1. FIGS. 3 to 8 are respectively diagrams showing examples of screens displayed on a display section included in the robot system shown in FIG. 1. FIGS. 9 to 11 are tables showing examples of data stored in a storing section included in the robot system shown in FIG. 1. FIG. 12 is a table showing an example of data input to the storing section included in the robot system shown in FIG. 1. FIG. 13 is a flowchart for explaining an example of a coping work display method according to the present disclosure.

A coping work display method, a coping work display program, and a robot system according to the present disclosure are explained in detail below based on a preferred embodiment shown in the accompanying drawings. In the following explanation, for convenience of explanation, about a robot arm, a base 11 side in FIG. 1 is referred to “proximal end” and the opposite side of the base 11 side, that is, an end effector 20 side in FIG. 1 is referred to as “distal end” as well.

As shown in FIG. 1, a robot system 100 includes a robot 1, a control device 3 that controls the robot 1, and a teaching device 4.

First, the robot 1 is explained.

In this embodiment, the robot 1 shown in FIGS. 1 and 2 is a single-arm six-axis vertical articulated robot and includes a base 11 and a robot arm 10. An end effector 20 can be attached to the distal end portion of the robot arm 10. The end effector 20 may be a constituent element of the robot 1 and may not be a constituent element of the robot 1.

The robot 1 is not limited to the configuration shown in FIG. 1 and may be, for example, a double-arm articulated robot. The robot 1 may be a horizontal articulated robot.

The base 11 is a supporting body that supports the robot arm 10 from the lower side to be capable of driving the robot arm 10. The base 11 is fixed to, for example, a floor in a factory. The base 11 of the robot 1 is electrically connected to the control device 3 via a relay cable. The connection of the robot 1 and the control device 3 is not limited to connection by wire in the configuration shown in FIG. 1 and may be, for example, connection by radio. Further, the robot 1 and the control device 3 may be connected via a network such as the Internet.

In this embodiment, the robot arm 10 includes a first arm 12, a second arm 13, a third arm 14, a fourth arm 15, a fifth arm 16, and a sixth arm 17. These arms are coupled in this order from the base 11 side. The number of arms included in the robot arm 10 is not limited to six and may be, for example, one, two, three, four, five, or seven or more. The sizes such as the total lengths of the arms are not respectively particularly limited and can be set as appropriate.

The base 11 and the first arm 12 are coupled via a joint 171. The first arm 12 has a first turning axis parallel to the vertical direction as a turning center and is capable of turning with respect to the base 11 around the first turning axis. The first turning axis coincides with the normal of the floor to which the base 11 is fixed.

The first arm 12 and the second arm 13 are coupled via a joint 172. The second arm 13 is capable of turning with respect to the first arm 12 with a second turning axis parallel to the horizontal direction as a turning center. The second turning axis is parallel to an axis orthogonal to the first turning axis.

The second arm 13 and the third arm 14 are couped via a joint 173. The third arm 14 is capable of turning with respect to the second arm 13 with a third turning axis parallel to the horizonal direction as a turning center. The third turning axis is parallel to the second turning axis.

The third arm 14 and the fourth arm 15 are coupled via a joint 174. The fourth arm 15 is capable of turning with respect to the third arm 14 with a fourth turning axis parallel to the center axis direction of the third arm 14 as a turning center. The fourth turning axis is orthogonal to the third turning axis.

The fourth arm 15 and the fifth arm 16 are coupled via a joint 175. The fifth arm 16 is capable of turning with respect to the fourth arm 15 with a fifth turning axis as a turning center. The fifth turning axis is orthogonal to the fourth turning axis.

The fifth arm 16 and the sixth arm 17 are coupled via a joint 176. The sixth arm 17 is capable of turning with respect to the fifth arm 16 with a sixth turning axis as a turning center. The sixth turning axis is orthogonal to the fifth turning axis.

The sixth arm 17 is a robot distal end portion located on the most distal end side in the robot arm 10. The sixth arm 17 can turn together with the end effector 20 according to driving of the robot arm 10.

The robot 1 includes a motor M1, a motor M2, a motor M3, a motor M4, a motor M5, and a motor M6 functioning as driving sections and an encoder E1, an encoder E2, an encoder E3, an encoder E4, an encoder E5, and an encoder E6. The motor M1 is incorporated in the joint 171 and causes the base 11 and the first arm 12 to relatively rotate. The motor M2 is incorporated in the joint 172 and causes the first arm 12 and the second arm 13 to relatively rotate. The motor M3 is incorporated in the joint 173 and causes the second arm 13 and the third arm 14 to relatively rotate. The motor M4 is incorporated in the joint 174 and causes the third arm 14 and the fourth arm 15 to relatively rotate. The motor M5 is incorporated in the joint 175 and causes the fourth arm 15 and the fifth arm 16 to relatively rotate. The motor M6 is incorporated in the joint 176 and causes the fifth arm 16 and the sixth arm 17 to relatively rotate.

The encoder E1 is incorporated in the joint 171 and detects the position of the motor M1. The encoder E2 is incorporated in the joint 172 and detects the position of the motor M2. The encoder E3 is incorporated in the joint 173 and detects the position of the motor M3. The encoder E4 is incorporated in the joint 174 and detects the position of the motor M4. The encoder E5 is incorporated in the fifth arm 16 and detects the position of the motor M5. The encoder E6 is incorporate in the sixth arm 17 and detects the position of the motor M6.

The encoders E1 to E6 are electrically connected to the control device 3. Position information, that is, rotation amounts of the motors M1 to M6 are transmitted to the control device 3 as electric signals. Based on the information, the control device 3 drives the motors M1 to M6 via motor drivers MD1 to MD6. That is, controlling the robot arm 10 means controlling the motors M1 to M6.

The encoders E1 to E6 also function as vibration detecting sections that detect vibration applied to the robot arm 10. The encoders E1 to E6 are not limited to this configuration. Other vibration meters may be used as vibration sensors.

In the robot 1, a force detecting section 19 that detects a force is detachably set in the robot arm 10. The robot arm 10 can be driven in a state in which the force detecting section 19 is set. In this embodiment, the force detecting section 19 is a six-axis force sensor. As explained below, the force detecting section 19 is a torque sensor that detects magnitudes of forces on three detection axes orthogonal to one another and magnitudes of torques around the three detection axes. The force detecting section 19 is not limited to the six-axis force sensor and may be a sensor having another configuration.

The end effector 20 can be detachably attached to the force detecting section 19. In this embodiment, the end effector 20 includes a pair of claw sections capable of approaching and separating from each other. The end effector 20 is configured by a hand that grips and releases a workpiece with the claw sections. The end effector 20 is not limited to the illustrated configuration and may be a hand that grips a work target object with attraction. The end effector 20 may be, for example, a polisher, a grinder, a cutter, or a tool such as a screwdriver or a wrench.

In a robot coordinate system, a tool center point TCP, which is a control point, is set at the distal end of the end effector 20. In the robot system 100, the tool center point TCP can be set as a reference of control by grasping the position of the tool center point TCP in the robot coordinate system.

A detecting section 50 detects an abnormality that occurs in the robot system 100. Specifically, examples of the abnormality that occurs in the robot system 100 include a failure of a robot element component, a failure of robot peripheral equipment, a decrease in a battery remaining power, and an unintended motion of the robot arm 10. Examples of the robot element component include an encoder, a speed reducer, and a motor. Examples of the robot peripheral equipment include the end effector 20, the force detecting section 19, an imaging section, and a material feeding and removing device such as a conveyor and a lifter.

The detecting section 50 includes a sensor that electrically detects these abnormalities. The detecting section 50 is electrically connected to the control device 3 and the teaching device 4. Information concerning the abnormality detected by the detecting section 50 is transmitted to the control device 3 or the teaching device 4 as an electric signal indicating an abnormality part and abnormality content.

The control device 3 and the teaching device 4 are explained.

As shown in FIG. 1, in this embodiment, the control device 3 is set in a position away from the robot 1. However, the control device 3 is not limited to this configuration and may be incorporated in the base 11. The control device 3 has a function of controlling driving of the robot 1 and is electrically connected to the sections of the robot 1 explained above. The control device 3 includes a control section 31, a storing section 32, and a communication section 33. These sections are communicably connected to one another via, for example, a bus.

The control section 31 is configured by, for example, a CPU (Central Processing Unit) and reads out and executes various programs such as an operation program stored in the storing section 32. A signal generated by the control section 31 is transmitted to the sections of the robot 1 via the communication section 33. Consequently, the robot arm 10 can execute predetermined work under predetermined conditions. The storing section 32 saves various programs and the like executable by the control section 31. Examples of the storing section 32 include a volatile memory such as a RAM (Random Access Memory), a nonvolatile memory such as a ROM (Read Only Memory), and a detachable external storage device. The communication section 33 performs transmission and reception of signals to and from the control device 3 using an external interface such as a wired LAN (Local Area Network) or a wireless LAN.

As shown in FIGS. 1 and 2, the teaching device 4 includes a display section 40 and has a function of, for example, creating an operation program and inputting the operation program to the robot arm 10. The teaching device 4 is not particularly limited. Examples of the teaching device 4 include a tablet terminal, a personal computer, a smartphone, and a teaching pendant.

Specifically, the teaching device 4 includes a control section 41, a storing section 42, and a communication section 43.

The control section 41 is configured by, for example, a CPU (Central Processing Unit) and reads out, for example, various programs such as a teaching program stored in the storing section 42. Further, the control section 41 reads out and acquires, from data stored in the storing section 42, coping work information related to an abnormality detected by the detecting section 50. That is, the control section 41 functions as an acquiring section that reads out and acquires, from the storing section 42, the coping work information related to the abnormality detected by the detecting section 50.

In the storing section 42, abnormality information indicating an abnormality that occurs in the robot 1 and a plurality of kinds of coping work information indicating coping work for eliminating the abnormality of the robot 1 related to the abnormality information are stored in association. This is explained below.

A coping work display program explained below is stored in such a teaching device 4. The coping work display program is executed, whereby a coping work display method according to the present disclosure is executed. Without being limited to the configuration explained above, the coping work display program may be stored in the control device 3.

When the detecting section 50 detects an abnormality, the teaching device 4 displays, on the display section 40, screens D1 to D6 shown in FIGS. 3 to 8.

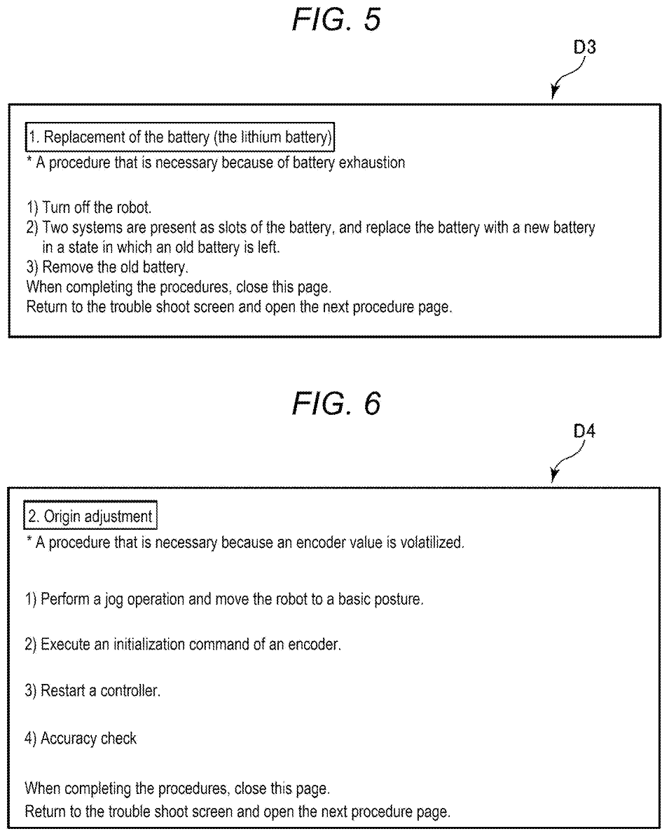

The screen D1 shown in FIG. 3 is, for example, a screen displayed when a battery voltage of an encoder drops. On the screen D1, characters “The encoder battery voltage has dropped. Please replace the battery.” is displayed as a warning. Below the characters, characters “Replacement of the battery (the lithium battery)” are displayed as a coping method. The characters “Replacement of the battery (the lithium battery)” are hyperlinked. A solution is displayed (see the screen D3 shown in FIG. 5).

On the screen D3 shown in FIG. 5, procedures of battery replacement are displayed. Specifically, procedures of “1) Turn off the robot.”, “2) Two systems are present as slots of the battery, and replace the battery with a new battery in a state in which an old battery is left.”, and “3) Remove the old battery.” are displayed.

On the screen D1, a QR code (registered trademark) is displayed in an upper right portion. When the QR code (registered trademark) is read by an external device, it is possible to view a page in which error states and solutions are collected (not shown).

The screen D2 shown in FIG. 4 is, for example, a screen displayed when encoder information is initialized and calibration is urged. On the screen D2, characters “Encoder information is initialized. Please carry out calibration.” is displayed as caution. Below the characters, as a coping method, procedures of “1. Replacement of the battery (the lithium battery)”, “2. Origin adjustment”, “3. Conveyor calibration”, and “4. Handling correction” are displayed.

In this way, in the robot system 100, the abnormality information and the plurality of kinds of coping work information indicating the coping work for eliminating the abnormality of the robot related to the abnormality information are displayed.

Characters of “1. Replacement of the battery (the lithium battery)”, “2. Origin adjustment”, “3. Conveyor calibration”, and “4. Handling correction” are hyperlinked. The following screens are displayed at link destinations.

When the characters of “1. Replacement of the battery (the lithium battery)” are selected, the screen D3 shown in FIG. 5 explained above is displayed.

When the characters of “2. Origin adjustment” are selected, the screen D4 shown in FIG. 6 is displayed.

On the screen D4, a procedure of adjustment of an origin position of the robot coordinate system is displayed. Specifically, procedures of “1) Perform a jog operation and move the robot to a basic posture.”, “2) Execute an initialization command of an encoder.”, “3) Restart a controller.”, and “4) Accuracy check” are displayed.

In the procedure of “1) Perform a jog operation and move the robot to a basic posture.”, a basic posture of the robot 1 corresponding to the procedure is displayed (not shown).

In the procedure of “2) Execute an initialization command of an encoder.”, a screen showing a command of “reset encoder” is displayed (not shown).

In the procedure of “3) Restart a controller.”, a GUI image screen of a restart procedure is displayed (not shown).

In the procedure of “4) Accuracy check”, a procedure for performing low speed check is displayed in order to determine whether to operate in an assumed motion (not shown).

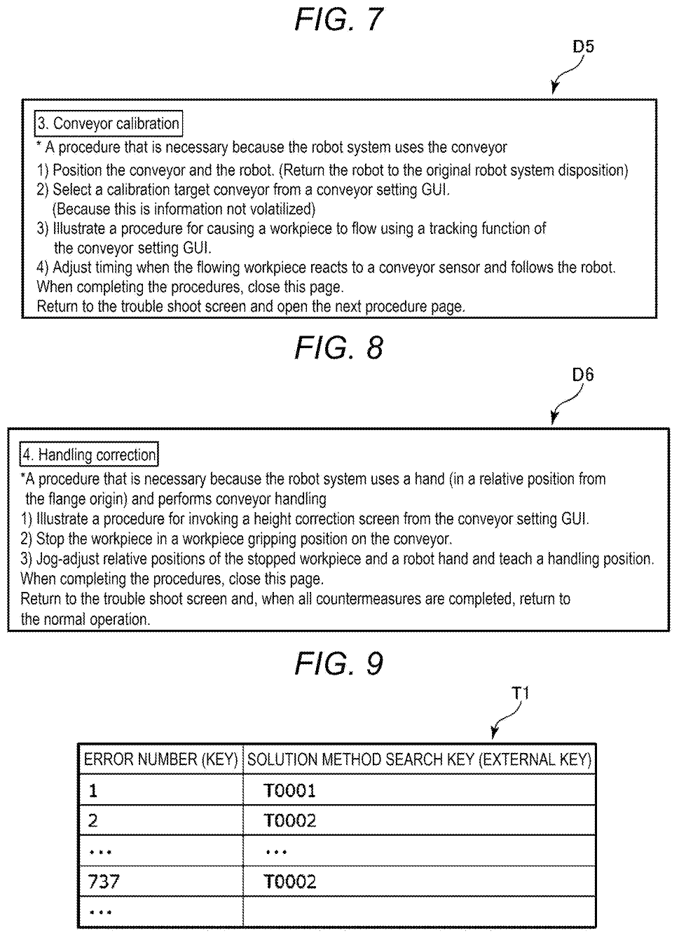

When the characters of “3. Conveyor” are selected on the screen D2 shown in FIG. 4, the screen D5 shown in FIG. 7 is displayed.

On the screen D5, a procedure for adjustment of the origin position of the robot coordinate system is displayed. Specifically, procedures of “1) Position the conveyor and the robot.”, “2) Select a calibration target conveyor from a conveyor setting GUI.”, “3) Illustrate a procedure for causing a workpiece to flow using a tracking function of the conveyor setting GUI.”, and “4) Adjust timing when the flowing workpiece reacts to a conveyor sensor and follows the robot.” are displayed. In the procedure of “1) Position the conveyor and the robot.”, the sections of the robot system 100 are returned to initial positions.

When the characters of “4. Handling correction” are selected on the screen D2 shown in FIG. 4, the screen D6 shown in FIG. 8 is displayed.

On the screen D6, a procedure of handling correction is displayed. Specifically, procedures of “1) Illustrate a procedure for invoking a height correction screen from the conveyor setting GUI.”, “2) Stop the workpiece in a workpiece gripping position on the conveyor.”, and “3) Jog-adjust relative positions of the stopped workpiece and a robot hand and teach a handling position.” are displayed.

By performing such display, while viewing the plurality of kinds of coping work information displayed on the display section 40, the operator can sequentially execute coping work for eliminating an abnormality. Coping work for coping with an abnormality related to detected abnormality information, that is, likely to derive from the detected abnormality information and occur is also displayed. Therefore, it is possible to more surely return the robot 1 to a normal state.

As explained above, the robot system 100 includes the detecting section 50 that detects an abnormality that occurs in the robot 1, the storing section 42 storing abnormality information indicating the abnormality that occurs in the robot 1 and a plurality of kinds of coping work information indicating coping work for eliminating the abnormality of the robot 1 related to the abnormality information, the control section 41 functioning as the acquiring section that acquires, based on a detection result of the detecting section 50, from the storing section 42, the plurality of kinds of coping work information related to the detected abnormality, and the display section 40 that displays the plurality of kinds of coping work information acquired by the control section 41. Consequently, when an abnormality occurs in the robot 1, the operator can perform work for eliminating the abnormality after checking the plurality of kinds of coping work information displayed on the display section 40. Accordingly, the operator can accurately and surely eliminate the abnormality. Further, since the coping work related to the detected abnormality information is also displayed, it is possible to more surely return the robot 1 to the normal state.

An example of data stored in the storing section 42 is explained.

In the storing section 42, the abnormality information indicating the abnormality that occurs in the robot 1 and the plurality of kinds of coping work information indicating the coping work for eliminating the abnormality of the robot 1 related to the abnormality information are linked and stored.

For example, as shown in FIG. 9, a table T1 indicating a relation between an error number and a solution method search key is stored in the storing section 42. The error number is a number decided according to a type of the abnormality that occurs in the robot 1. The solution method search key is a key for searching for a method for eliminating the abnormality indicated by the error number.

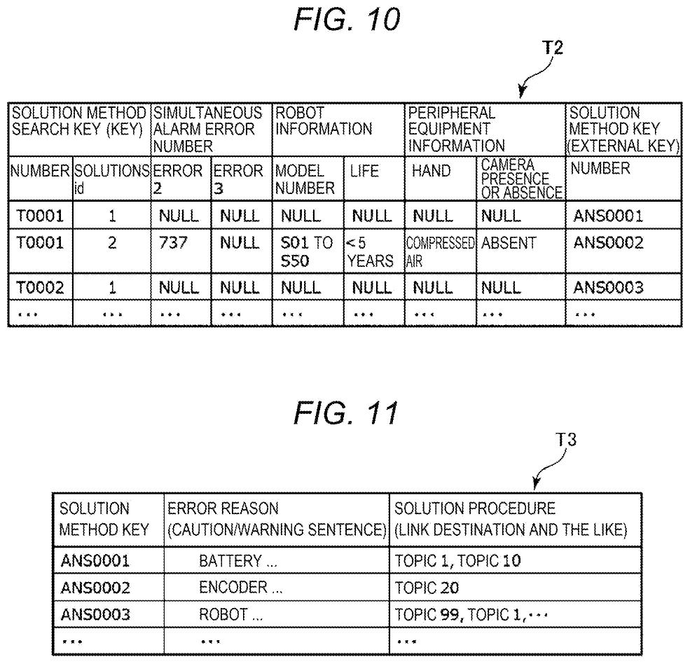

For example, as shown in FIG. 10, a table T2 indicating a relation among a solution method search key, a simultaneous alarm error number, robot information, peripheral equipment information, and a solution method key is stored in the storing section 42. The simultaneous alarm error number is information concerning an abnormality that tends to occur or occurs deriving from abnormality information detected by the detecting section 50. The robot information is individual information indicating a model number, a life, and the like. The peripheral equipment information is information indicating the end effector 20, the imaging section, and the like. The solution method key is a key indicating a method for eliminating the abnormality indicated by the error number.

Information concerning the material feeding and removing device (a feeding and removing section) explained above may be included in the table T2.

With such a table T2, it is possible to acquire information such as the simultaneously alarm error number, the robot information, and the peripheral equipment information and cause the display section 40 to display the information.

For example, as shown in FIG. 11, a table T3 indicating a relation among a solution method key, an error reason, and a solution procedure is stored in the storing section 42. The error reason concerns character information for displaying a type of a specific cause as caution or a warning sentence. The solution procedure concerns character information of a specific solution procedure.

For example, since such tables T1 to T3 are stored in the storing section 42, the control section 41 can acquire the plurality of kinds of coping work information explained above from the storing section 42.

Such data can be generated as explained below.

In FIG. 12, a table H1 showing an input element and a way of using input information is shown.

Examples of the input element include an error number, robot information, and peripheral equipment information.

Examples of the robot information include a model number, a serial number, a predicted life, an intra-system error history, and an axis on which an error occurs. Examples of the peripheral equipment information include a hand form, camera presence or absence, force sense presence or absence, and a material feeding and removing device.

Ways of using these kinds of information are as follows.

The information of the model number and the serial number can be collated with information of recall and the like. The information of the predicted life can be used to grasp a tendency of an error that tends to occur. The information of the intra-system error history can be used to grasp the tendency of the error that tends to occur. The information of the axis on which an error occurs, that is, the information concerning the position of a joint where an error occurs can be used as a filter for an error and a solution. The information of the hand form, the camera presence absence, the force sense presence or absence, and the material feeding and removing device can be used as the filter for an error and a solution.

Such information is displayed in step S106 explained below.

In this way, the abnormality information includes information concerning a plurality of abnormalities that simultaneously occur. Consequently, the operator can grasp a plurality of kinds of abnormality information and coping work information for the plurality of kinds of abnormality information. Accordingly, it is possible to eliminate the plurality of abnormalities.

The abnormality information is associated with information related to coping work (related information). The plurality of kinds of coping work information are acquired from the storing section 42 based on the abnormality information and the related information. Consequently, the operator can grasp an abnormality that tends to occur deriving from an occurring abnormality.

The related information includes information of a history of abnormalities that occurred in the past and a number of a joint having an abnormality (a joint axis number). Consequently, it is possible to display coping work considering, in particular, an abnormality that tends to occur and a place where an abnormality tends to occur.

The related information includes at least one of a model number and a life. Consequently, recall information can also be included in information for making determination. It is possible to further improve accuracy of selection of coping work information. When the related information includes both of the model number and the life, it is possible to further improve the accuracy of selection of coping work information.

The related information includes at least one of information concerning the set end effector 20, information concerning a set force sensor, that is, the force detecting section 19, information concerning a camera associated with the force sensor, and information concerning a material feeding and removing device (a feeding and removing section) associated with the force sensor. Consequently, it is possible to further improve the accuracy of selection of coping work information. If the related information includes two or more of these kinds of information, it is possible to further improve the accuracy of selection of coping work.

By causing the storing section 42 to store the input elements in this way, it is possible to accumulate data necessary for executing the coping work display method according to the present disclosure.

An example of a coping work display method according to the present disclosure is explained with reference to the flowchart of FIG. 13.

First, in step S100, the detecting section 50 detects an abnormality that occurs in the robot 1. Step S100 is a first step.

Subsequently, in step S101, the control section 41 acquires a solution method search key from a generated error number. That is, the control section 41 specifies an error number based on abnormality information detected by the detecting section 50 and acquires the solution method search key using the tables T1 to T3 explained above.

Subsequently, in step S102, the control section 41 executes solution method search processing. That is, the control section 41 searches for coping work information corresponding to the abnormality referring to the tables explained above.

Subsequently, in step S103, the control section 41 determines whether a plurality of solutions are present. That is, the control section 41 determines, referring to the tables explained above, whether coping work information corresponding to the abnormality is stored.

When determining in step S103 that a plurality of solutions are present, the control section 41 shifts to step S105. When determining in step S103 that a plurality of solutions are absent, the control section 41 shifts to step S104. In step S105, the control section 41 specifies solution data (coping work information) with which a solution method key coincides and sends the solution data to the display section 40. In step S104, the control section 41 acquires only a solution method key with which the error number coincides and shifts to step S105.

As explained above, the control section 41 acquires the solution method key corresponding to the type of the abnormality and acquires the coping work information. Steps S102 to S105 are a second step.

Subsequently, in step S106, the control section 41 displays, on the display section 40, the coping work information acquired in step S105. Step S106 is a third step.

As explained above, the coping work display method according to the present disclosure is a method of displaying coping work executed when an abnormality occurs in the robot 1. The coping work display method includes the first step of detecting the abnormality that occurs in the robot 1, the second step of acquiring, from the storing section 42 storing abnormality information indicating the abnormality that occurs in the robot 1 and a plurality of kinds of coping work information indicating coping work for eliminating the abnormality of the robot 1 related to the abnormality information, the plurality of kinds of coping work information related to the abnormality detected in the first step, and the third step of displaying the plurality of kinds of coping work information acquired in the second step. Consequently, when an abnormality occurs in the robot 1, the operator can perform work for eliminating the abnormality after checking the plurality of kinds of coping work information displayed on the display section 40. Accordingly, the operator can accurately and surely eliminate the abnormality. Further, since the coping work related to the detected abnormality information is also displayed, it is possible to more surely return the robot 1 to a normal state.

In the third step, it is preferable to display the plurality of kinds of coping work information in order based on priority levels. Consequently, the operator can eliminate the abnormality according to the priority levels. The operator can also perform selection of abnormality coping work by grasping the priority levels in advance.

A coping work display program according to the present disclosure is a program for displaying coping work executed when an abnormality occurs in the robot 1. The coping work display program is a program for executing the first step of detecting the abnormality that occurs in the robot 1, the second step of acquiring, from the storing section 42 storing abnormality information indicating the abnormality that occurs in the robot 1 and a plurality of kinds of coping work information indicating coping work for eliminating the abnormality of the robot 1 related to the abnormality information, the plurality of kinds of coping work information related to the abnormality detected in the first step, and the third step of displaying the plurality of kinds of coping work information acquired in the second step. By executing such a program, when an abnormality occurs in the robot 1, the operator can perform work for eliminating the abnormality after checking the plurality of kinds of coping work information displayed on the display section 40. Accordingly, the operator can accurately and surely eliminate the abnormality. Further, since the coping work related to the detected abnormality information is also displayed, it is possible to more surely return the robot 1 to a normal state.

The coping work display program may be stored in the storing section 32, may be stored in the storing section 42, or may be stored in another storage device or storage medium capable of communicating via a network.

The coping work display method, the coping work display program, and the robot system according to the present disclosure are explained above based on the illustrated embodiment. However, the present disclosure is not limited to this. The steps and the sections of the coping work display method, the coping work display program, and the robot system can be substituted with any steps and structures that can exert the same functions. Any steps and structures may be added.

What is claimed is:

1. A coping work display method for displaying coping work executed when an abnormality occurs in a robot, the coping work display method comprising:
a first step of detecting the abnormality that occurs in the robot;
a second step of acquiring, from a storing section storing abnormality information indicating the abnormality that occurs in the robot and a plurality of kinds of coping work information indicating coping work for eliminating the abnormality of the robot related to the abnormality information, the plurality of kinds of coping work information related to the abnormality detected in the first step; and
a third step of displaying the plurality of kinds of coping work information acquired in the second step.

2. The coping work display method according to claim 1, wherein, in the third step, the plurality of kinds of coping work information are displayed in order based on priority levels.

3. The coping work display method according to claim 1, wherein the abnormality information includes information concerning a plurality of abnormalities that simultaneously occur.

4. The coping work display method according to claim 1, wherein
the abnormality information is associated with related information related to coping work, and
the plurality of kinds of coping work information are acquired from the storing section based on the abnormality information and the related information.

5. The coping work display method according to claim 4, wherein the related information includes information of a history of abnormalities that occurred in past and a joint axis number of a joint having an abnormality.

6. The coping work display method according to claim 4, wherein the related information includes at least one of a model number and a life.

7. The coping work display method according to claim 4, wherein the related information includes at least one of information concerning a set end effector, information concerning a set force sensor, information concerning a camera associated with the force sensor, and information concerning a feeding and removing section associated with the force sensor.

8. A non-transitory recording medium recording a coping work display program for displaying coping work executed when an abnormality occurs in a robot, the non-transitory recording medium recording a coping work display program for executing:
a first step of detecting the abnormality that occurs in the robot;
a second step of acquiring, from a storing section storing abnormality information indicating the abnormality that occurs in the robot and a plurality of kinds of coping work information indicating coping work for eliminating the abnormality of the robot related to the abnormality information, the plurality of kinds of coping work information related to the abnormality detected in the first step; and
a third step of displaying the plurality of kinds of coping work information acquired in the second step.

9. A robot system comprising:
a detecting section configured to detect an abnormality that occurs in a robot;
a storing section storing abnormality information indicating the abnormality that occurs in the robot and a plurality of kinds of coping work information indicating coping work for eliminating the abnormality of the robot related to the abnormality information;
an acquiring section configured to acquire, based on a detection result of the detecting section, the plurality of kinds of coping work information related to the detected abnormality from the storing section; and
a display section configured to display the plurality of kinds of coping work information acquired by the acquiring section.
